(19) United States
(12) Patent Application Publication
(10) Pub. No.: US 2022/0191747 A1
(43) Pub. Date: Jun. 16, 2022

(54) METHODS AND APPARATUS RELATING TO HANDOVER OF A WIRELESS DEVICE

(71) Applicant: Telefonaktiebolaget LM Ericsson (publ), Stockholm (SE)

(72) Inventors: Dusan IGNJATOVIC, Stockholm (SE); Håkan Österlund, Ekerö (SE)

(73) Assignee: Telefonaktiebolaget LM Ericsson (publ), Stockholm (SE)

(21) Appl. No.: 17/594,000

(22) PCT Filed: Mar. 29, 2019
(86) PCT No.: PCT/SE2019/050289

§ 371 Date: Sep. 29, 2021

(51) Int. Cl. H04W 36/00; H04W 36/08; H04L 65/10; H04L 65/1045

(52) U.S. Cl. CPC H04W 36/0022; H04L 65/105; H04L 65/1006; H04W 36/08

(57) ABSTRACT

A method performed by a first intermediate node in an ongoing communication session between a first network node and a second network node in a communication network is provided. The method comprises: receiving an indication that handover of a first network node from a first radio access network to a second radio access network has occurred during the ongoing communication session; generating a message comprising a header, wherein the header identifies the second radio access network; and transmitting the message to a second intermediate node in the ongoing communication session.

### TECHNICAL FIELD

Embodiments of the present disclosure relate to handover of a network node, for example a wireless device, from a first radio access network to a second radio access network, and particularly to handover of a network node during an ongoing communication session with another network node.

### BACKGROUND

In New Radio (NR) and Long Term Evolution (LTE), voice calls between wireless devices are delivered over the Internet Protocol (IP) Multimedia Subsystem (IMS). In general, IMS is used to deliver media services over IP, including, for example, voice, video and messaging services. IMS services may be implemented using the Session Initiation Protocol (SIP), which enables establishment of communication sessions between nodes in a communication network.

Current IMS solutions support co-existence between 2G, 3G and 4G radio access networks (for example, Single radio Voice Call Continuity—SR VCC) so that a voice call that was initiated on one radio access network may be transferred to another radio access network during the call. With the introduction of New Radio, similar proposals are being advanced for handover between 4G and 5G networks, to allow a device to switch radio access networks without affecting an ongoing voice call. However, with the current level of functionality provided by the current IMS solutions, such as subscriptions that can be made for notifications to changes in radio access technology, only the edge node in the IMS network (e.g. a Proxy Call Session Control Function (P-CSCF)) may be aware that a handover between 5G and 4G has happened in a voice call.

One problem with these proposals is that the particular radio access network used by a wireless device for a voice call may affect the charges assigned to the call. For example, voice calls made via a 4G radio access network may be charged at one rate, and voice calls made with a 5G radio access network may be charged at another rate. As a result, a voice call from a wireless device that changes radio access network during the call may be charged incorrectly. In addition, statistics and performance indicators that are used to monitor the provision of services via radio access networks may be determined assuming the wireless device remains connected to its initial radio access network, thereby distorting the statistics and performance indicators for that radio access network.

If only an edge node in the IMS network is aware of the occurrence of the handover, then the charging of the call and the statistics and performance indicators may be performed by the network incorrectly.

### SUMMARY

According to some embodiments there is provided a method performed by a first intermediate node in an ongoing communication session between a first network node and a second network node in a communication network. The method comprises receiving an indication that handover of a first network node from a first radio access network to a second radio access network has occurred during the ongoing communication session; generating a message comprising a header, wherein the header identifies the second radio access network; and transmitting the message to a second intermediate node in the ongoing communication session.

According to some embodiments there is provided a method performed by a first intermediate node in an ongoing communication session between a first network node and a second network node in a communication network. The method comprises receiving a message indicating that handover of the first network node from a first radio access network to a second radio access network has occurred during the ongoing communication session, the message comprising a header, wherein the header identifies the second radio access network; and forwarding the message to a second intermediate network node in the ongoing communication session.

According to some embodiments there is provided a method performed by a first intermediate node in an ongoing communication session between a first network node and a second network node in a communication network. The method comprises receiving a first message indicating that handover of the first network node from a first radio access network to a second radio access network has occurred during the ongoing communication session, the first message comprising a header, wherein the header identifies the second radio access network; generating a second message comprising the header; and transmitting the second message to an entity in the communication network.

According to some embodiments there is provided a first intermediate node in an ongoing communication session between a first network node and a second network node in a communication network. The first intermediate node comprises processing circuitry configured to receive an indication that handover of a first network node from a first radio access network to a second radio access network has occurred during the ongoing communication session; generate a message comprising a header, wherein the header identifies the second radio access network; and transmit the message to a second intermediate node in the ongoing communication session.

According to some embodiments there is provided a first intermediate node in an ongoing communication session between a first network node and a second network node in a communication network. The first intermediate node comprises processing circuitry configured to receive a message indicating that handover of the first network node from a first radio access network to a second radio access network has occurred during the ongoing communication session, the message comprising a header, wherein the header identifies the second radio access network; and forward the message to a second intermediate network node in the ongoing communication session.

According to some embodiments there is provided a first intermediate node in an ongoing communication session between a first network node and a second network node in a communication network. The first intermediate node comprises processing circuitry configured to: receive a first message indicating that handover of the first network node from a first radio access network to a second radio access network has occurred during the ongoing communication session, the first message comprising a header, wherein the header identifies the second radio access network; generate a second message comprising the header; and transmit the second message to an entity in the communication network.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 illustrates an example of a system for delivering a communications session between two wireless devices:

FIG. 2 illustrates an example communication flow during a voice call between a first wireless device and a network node;

FIG. 3 illustrates an example signaling diagram for communicating handover of a wireless device during an ongoing communications session;

FIG. 4 illustrates a method performed by a first intermediate node in an ongoing communication session between a first network node and a second network node in a communications network according to some embodiments;

FIG. 5 illustrates a method performed by a first intermediate node in an ongoing communication session between a first network node and a second network node in a communication network according to some embodiments;

FIG. 6 illustrates a method performed by a first intermediate node in an ongoing communication session between a first network node and a second network node in a communication network according to some embodiments;

FIG. 7 illustrates a method performed by a system in an ongoing communication session between a first network node and a second network node in a communication network according to some embodiments; and

FIGS. 8, 9 and 10 illustrate respective intermediate nodes according to embodiments of the disclosure.

### DETAILED DESCRIPTION

The following sets forth specific details, such as particular embodiments for purposes of explanation and not limitation. But it will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

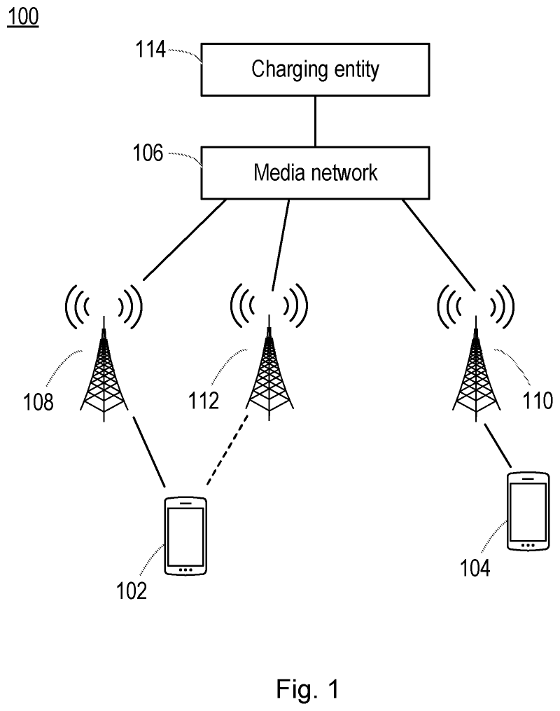

FIG. 1 illustrates an example of a communication system 100. The system 100 comprises a first wireless device 102 and a second wireless device 104, which are connected to a media network 106 via a first radio access network 108 and a second radio access network 110 respectively.

The media network 106 facilitates the establishment and management of communication sessions including one or both of the first and second wireless devices 102, 104. Thus, for example, a voice call between the first wireless device 102 and the second wireless device 104 may be routed via the first and second radio access networks 108, 110 and the media network 106. In some examples, the media network 106 is an Internet Protocol (IP) Multimedia Subsystem (IMS) network. The IMS network may implement one or more communication protocols, such as, for example, Session Initiation Protocol (SIP) or Session Description Protocol (SDP). It will also be appreciated that in some examples, the media network 106 may facilitates the establishment and management of a communication session between an applications server and one or more of the first and second wireless device 102, 104. For example, the communication session may comprise a video streaming session.

The communication system 100 further comprises a charging entity 114, which is in communication with the media network 106. The charging entity 114 may configured to provide online charging or offline charging for the communication session between the first wireless device and the second wireless device 102, 104. For example, the charging entity 114 may be a Charging Data Function (CDF) or an Online Charging Function (OCF). Communications between the media network 106 and the charging entity 114 may be transmitted over a Diameter interface such as, for example, a Diameter Rf interface or a Diameter Ro interface.

The communication system 100 further comprises a third radio access network 112, which is also connected to the media network 106. Thus, in the event that handover of the first wireless device 102 from the first radio access network 108 to the third radio access network 112 occurs, the first wireless device 102 retains access to the media network 106 via the third radio access network 112. Those skilled in the art will appreciate that although the radio access networks 108-112 are symbolized by a single radio access node in FIG. 1, each of the radio access networks 108-112 may comprise one or more radio access nodes. In addition, the radio access networks 108-112 may be connected to the media network 106 via one or more backhaul network and/or core network nodes, which are omitted from FIG. 1 for simplicity.

The radio access networks 108-112 may implement any suitable wireless communications protocol or technology, for example, Global System for Mobile communication (GSM), Wide Code-Division Multiple Access (WCDMA), Long Term Evolution (LTE), New Radio (NR), WiFi, WiMAX, or Bluetooth wireless technologies. In particular examples, the first and second radio access networks 108, 110 form part of cellular telecommunications networks, such as the type developed by the 3^{rd} Generation Partnership Project (3GPP).

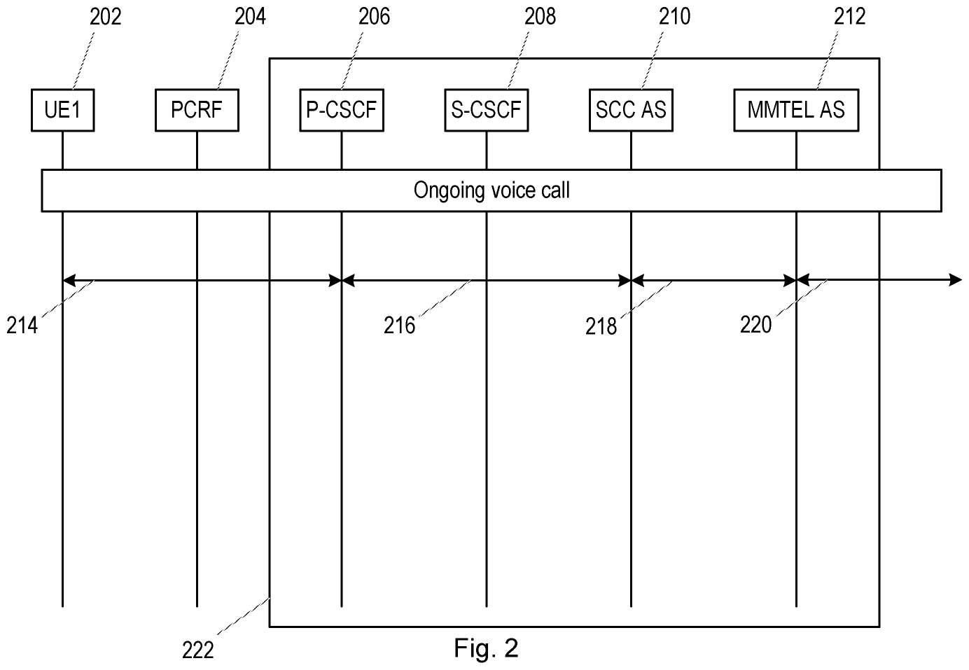

FIG. 2 shows an example communication flow between a first network node 202 and a second network node (not illustrated) during a voice call between the first network node 202 and the second network node. The first network node may be, for example, the first wireless device 102 illustrated in FIG. 1. The voice call between the first network node and the second network node is transmitted over media network between the first network node and the second network node. The media network comprises a home media network 222 for the first network node and a remote media network (not illustrated) for the second network node. The home media network 222 and the remote media network may thus, for example, form part of the media network 106 described above in relation to FIG. 1.

As illustrated in FIG. 2, there may be a plurality of intermediate nodes 204-212 between the first network node 202 and the second network node in the communication flow. In this example, the plurality of intermediate nodes 204-212 comprises a Policy and Charging Rules Function (PCRF) 204 and plurality of media network nodes 206-212 in the home media network 222. The PCRF determines policy rules for the home media network 222. In the illustrated example, the home media network 222 is an IMS network, and the PCRF applies subscriber and service-centric policy control capabilities to the home media network 222. The PCRF may support one or more policies including, for example, policies relating to service access control, quality of service (QoS) control, and charging control.

The first network node 202 may be connected to the PCRF 204 via one or more nodes in a radio access network (not illustrated). In some embodiments, the PCRF 204 may be a core network node. For example, the first network node 202 may be connected to a 4G radio access network (e.g. an LTE radio access network), such that the first network node 202 is in communication with the PCRF 204 in an Evolved Packet Core (EPC) network via the 4G radio access network. In another example, the radio access network may be a 5G radio access network (e.g. a New Radio radio access network) and the PCRF 204 may be located in a 5G core network.

As noted above, an IMS network may use a number of communication protocols, including, for example, Session Initiation Protocol (SIP). SIP is a signaling protocol for signalling and controlling media sessions such as voice, video and messaging sessions. In the example illustrated in FIG. 2, SIP is used to manage the ongoing voice call between the first network node 202 and the second network node. In accordance with SIP, a number of dialogs are established between the first network node 202 and the second network node to forward SIP messages transmitted by the first network node 202 and the second network node. A dialog may be defined as a peer-to-peer SIP relationship between two nodes. For example, a dialog may comprise a series of SIP transactions used to setup, modify and teardown an SIP session.

In the illustrated example, a first dialog 214 is established between the first network node and a Proxy Call Session Control Function (P-CSCF) 206, which is an edge node in the home media network 222. The P-CSCF 206 is a point of access to the home media network 222 for the first network node 202, supporting an access network interface (e.g. a User-to-Network Interface) between the first network node 202 and the home media network 222. The P-CSCF 206 hides the internal topology of the home media network 222 from the network node 202. The P-CSCF 206 may be configured to manage signalling and media sessions to ensure security and Quality of Service (QoS) requirements, and Service Level Agreements (SLAs) are met. The P-CSCF 206 may also enable Network Address Translator/Fire Wall (NAT/FW) traversal and other functions relating to the ongoing voice call.

A second dialog 216 is established between the P-CSCF 206 and a Service Centralization and Continuity Application Server (SCC AS) 210. The SCC AS 210 performs actions related to Single Radio Voice Call Continuity (SRVCC) and IMS Service Continuity (ICS). For example, an Access Transfer Control Function (ATCF) may be informed during registration to invoke a specific SCC AS instance, and the SCC AS may then renegotiate a new communication session with the remote media network. The SCC AS may further terminate an existing negotiated communication session with the remote media network.

In another example, the SCC AS may determine whether the home media network or 222 another network (e.g. a circuit switched network) will service a voice call (e.g. the SCC may perform Service Domain Selection, SDS). In a further example, the SCC AS may determine an access network for call delivery (e.g. the SCC AS may be involved in Terminating Access Domain Selection, T-ADS).

The second dialog 216 may be routed via a Serving Call Session Control Function (S-CSCF) 208. The S-CSCF 208 may perform session control services for the network node 202. The S-CSCF may also maintain a session state for supporting services and performs routing according to routing procedures, and may interact with a home subscriber server (HSS) for the first network node 202 to obtain subscriber data and exchange authentication information. The S-CSCF 208 may decide whether an application server receives information related to a SIP session request to ensure appropriate service handling based on information received from the HSS.

A third dialog 218 is established between the SCC AS 210 and a Multimedia Telephony Application Server (MMTel AS) 212. The MMTel AS 212 provides multimedia telephony services and supplementary services according to network standards. For example, the MMTel AS 212 may provide services in accordance with standards established by the 3GPP. The services may include, for example, include Public Switched Telephone Network (PSTN) and Integrated Services Digital Network (ISDN) Simulation Services as defined by the Telecoms and Internet converged Service and Protocols for Advanced Networks (TISPAN).

A fourth dialog 220 is established from the MMTel AS 212 to a further node in the home media network (not illustrated). The further node may be an edge (or last) node in the home media network. Alternatively, the MMTel AS 212 may be an edge (or last) node in the home media network. The home media network 222 may form a trust domain. Thus, contents of messages transmitted over the fourth dialog 220 may be restricted to prevent sensitive information from leaving the trust domain.

Therefore, an ongoing voice call between the first network node 202 and the second network node may be managed in accordance with SIP. Messages initiated by the first network node 202 and the second network node are forwarded across the dialogs 214-220 by the intermediate nodes 204-212.

As discussed above, the particular radio access network used by a network node for a voice call may affect the charges assigned to the call. With the level of functionality provided by current IMS solutions, only the edge node (for example the P-CSCF 206) in an IMS network may be aware that a handover of a network node between 5G and 4G has happened in a voice call. If only an edge node in the IMS network is aware of the occurrence of the handover, then the charging of the voice call to the user of the first network node, and the statistics and performance indicators may be performed by the network incorrectly.

Embodiments of the disclosure address these and other problems. According to one aspect, in response to receiving an indication that handover of the first network node from a first radio access network to a second radio access network has occurred during an ongoing communication session, a first intermediate node in the ongoing communication session generates a first message comprising a header identifying the second radio access network. The first intermediate node then transmits the first message to a second intermediate node in the ongoing communication session. The second intermediate node receives the first message and forwards it. A third intermediate node receives the forwarded message (directly or indirectly from the intermediate node) and generates a second message comprising the header. The second message is then transmitted, by the third intermediate node, to a charging entity in the communication network.

The embodiments described herein thus allow for more accurately monitoring and charging communication sessions in communication networks. In addition, by generating the first message in an intermediate node, rather relying the message being generated by the first network node, the embodiments described herein enable more accurately monitoring and charging communication sessions without requiring intervention from the first network node.

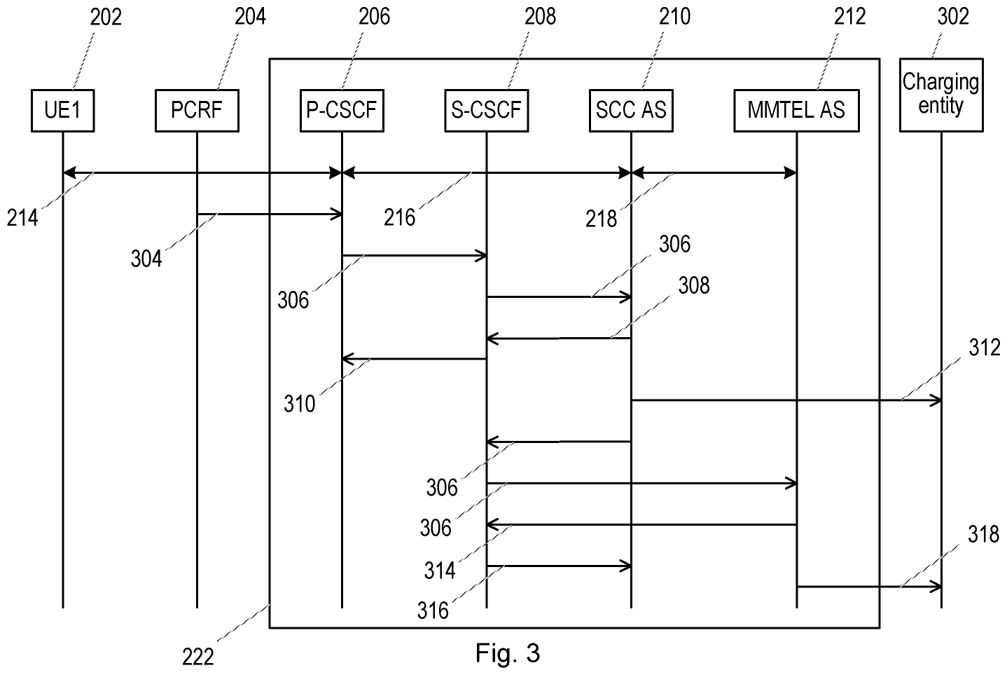

FIG. 3 is a signalling diagram according to embodiments of the disclosure. The signalling diagram relates to handover of a first network node 202 from a first radio access network to a second radio access network during a voice call between the first network node 202 and a second network node. One or both of the first network node 202 and the second network node may be a wireless device, a terminal device, a server, a user agent or any other suitable network node.

The voice call is transmitted over a home media network 222. The voice call is managed using SIP, according to which the series of dialogs 214-218 between the first network node 202 and intermediate nodes 206-212 have been established, for example as described above with reference to FIG. 2.

The procedure begins with a PCRF 204 transmitting an indication 304 to a P-CSCF 206 in the home media network 222 that handover of the first network node 202 from a first radio access network to a second radio access network has occurred during the ongoing voice call. The first and second radio access networks may implement the same or different radio access technologies. For example, the first radio access network may be a 4G radio access network and the second radio access network may be 5G radio access network, or vice-versa. In another example, both the first radio access network and the second radio access networks are 5G radio access networks.

The PCRF may transmit the handover indication in response to the home media network 222 (for example the P-CSCF 206) being subscribed to receive notifications when the first network node changes radio access network. The home media network 222 may be subscribed to receive a notification whenever the first network node 202 changes radio access network or, for example, to receive a notification only when handover of the first network node 202 from a radio access network of one radio access technology to another radio access network of a different radio access technology occurs. Thus, in some examples, the PCRF only transmits the handover indication if the first radio access network and the second radio access network use different radio access technologies. In other examples, the PCRF transmits the handover indication regardless of the radio access technologies used by the first and second radio access networks.

The handover indication 304 may comprise location information for the first network node 202. The location information may indicate a location of the first network node in a network. Additionally or alternatively, the location information may indicate a geographical location of the first network node. The location information may thus, for example, identify a cell serving the first network node (e.g. the location information may comprise a Cell Global ID (CGI)), identify a network serving the first network node 202 (e.g. the location information may comprise a Public Land Mobile Network, PLMN, identifier), and/or identify a set of users with connectivity access to a cell (e.g. a Closed Subscriber Group, CSG, identifier). In particular examples, the location information may comprise Network Provided Location Information (NPLI) for the first network node 202. The location information may further comprise an IP Connectivity Access Network-Type (IP-CAN-Type) attribute-value-pair (AVP) and/or a Radio Access Technology (RAT-Type) AVP.

The P-CSCF 206 may optionally request supplementary location information for the first network node 202. The supplementary location information may be requested in the absence of location information in the handover indication 304 or in addition to the location information in the handover indication 304. For example, the P-CSCF 206 may request information indicating a cell serving the first network node 202, (e.g. a Cell Global ID, CGI). Additionally or alternatively, the P-CSCF 206 may request information identifying a service area for the first network node 202 (e.g. a Service Area Identifier, SAI). In particular examples, the P-CSCF 206 may request a 3GPP-User-Location-Info attribute-value-pair from the PCRF 204.

The P-CSCF 206 generates a first message 306 comprising a header identifying the second radio access network. The P-CSCF 206 may generate the first message 306 in response to receiving the handover indication 304. The P-CSCF 206 may generate the header in response to receiving the handover indication 304. The header may indicate a radio access technology or protocol implemented by the second radio access network. For example, the header may indicate that the second radio access network is a NR radio access network. In an alternative example, the header may indicate that the second radio access network is a LTE network. The header may, additionally or alternatively, uniquely identify the second radio access network. Thus, the header indicates the radio access network serving the first network node after the handover has occurred.

The header may further identify a cell serving the first network node 202. For example, the header may comprise a Cell Global ID (CGI) for the cell serving the first network node 202. In particular embodiments, the header may be a Private Access Network Indicator (PANI) header.

The P-CSCF 206 may optionally update stored location information based on the received location information. For example, the P-CSCF 206 may store an indication of the radio access technology used by the radio access network serving the first network node 202, which may be updated based on the RAT-Type AVP received from the PCRF 204. In a further example, the P-CSCF 206 may store information indicating the cell serving the first network node 202, which may be updated based on location information received from the PCRF 204 in the handover indication 304 and/or in response to the request for supplementary location information. In some examples, the P-CSCF 206 stores the header that forms part of the first message 306. Thus, for example, the P-CSCF 206 may store a PANI header that forms part of the first message 306.

The P-CSCF 206 transmits the first message 306 to an S-CSCF 208 in the home media network 222. The S-CSCF 208 then forwards the first message 306 to an SCC AS 210 in the home media network 222. The first message 306 may be transmitted on the existing dialog 216 between the P-CSCF 206 and the SCC AS 210. This transmission of the first message 306 therefore utilizes the existing dialog 216 between the P-CSCF 206 and the SCC AS 210 which had been set up for SIP protocol messages that originate from the first network node 202 or the second network node. The use of this existing dialog for a message generated by the P-CSCF 206 therefore allows for the transmission of the relevant handover information to the other relevant intermediate nodes in the home network, without having to rely on messages being initiated by the first network node 202. In addition, generating the message at the P-CSCF 206 allows the relevant handover information to be communicated to the other relevant intermediate nodes in response to the handover occurring, rather than having to wait for a message to be sent by the first network node 202.

On receipt of the message 306, the SCC AS 210 transmits an acknowledgement 308 to the S-CSCF 208, which then transmits an acknowledgement 310 to the P-CSCF.

As noted above, the header in the first message 306 may further comprise location information for the first network node 202. On receipt of the first message 306, the SCC AS 210 may further update stored location information for the first network node 202 based on the received location information. Thus, for example, SCC AS 210 may update a stored CGI for the first network node 202 based on the received location information.

The SCC AS 210 may, optionally, generate a first charging information message 312 based on the header in the received message 306. The first charging information message 312 may comprise the header. Alternatively, the SCC AS 210 may extract relevant charging and/or location information from the header, and generate the first charging information message 312 based on the extracted information. The SCC AS 210 may then transmit the first charging information message 312 to a charging entity 302. The charging entity may be, for example, the charging entity 114 described in relation to FIG. 1. Thus, the charging entity may be, for example, a CDF and the first charging information message 312 may be transmitted over a Diameter Rf interface. In an alternative example, the charging entity may be an OCF and the charging information message may be transmitted over a Diameter Ro interface.

The SCC AS 210 may, additionally or alternatively, determine one or more performance indicators and/or statistics based on the charging and/or location information extracted from the first message 306. The performance indicators may be indicative of the performance of, for example, one or more of: the first radio access network, the second radio access network and the first network node 202. The performance indicators may include one or more key performance indicators (KPIs) indicative of, for example, accessibility, retainability, integrity, availability and/or mobility of a session and/or a network. The performance indicators may be specific to a particular type of radio access network. The performance indicators may include an indication of a handover success rate (e.g. a handover ratio). The performance indicators may be specific to the SCC AS 210. For example, the performance indicators may include an indicator of the accessibility of the SCC AS 210.

The SCC AS 210 forwards the first message 306 to an MMTel AS 212 in the home media network 222. The first message 306 may be forwarded over the subsequent dialog 218 in the communication session. The first message may be transmitted directly or indirectly to the MMTel AS 212. In the illustrated example, the first message is transmitted from the SCC AS 210 to the MMTel AS 212 over the dialog 218 by first forwarding the first message 306 from the SCC AS 210 to the S-CSCF 208 and then forwarding the first message 306 from the S-CSCF 208 to the MMTel 212 AS.

On receipt of the forwarded message 306, the MMTel AS 212 transmits an acknowledgement 314 to the S-CSCF 208, which in turn transmits an acknowledgement 316 to the SCC AS 210. In alternative examples in which the SCC AS 210 forwards the message directly to the MMTel AS 212, an acknowledgement may be transmitted directly from the MMTel AS 212 to the SCC AS 210.

The MMTel AS 212 generates a second message 318 based on the received first message 306. The second message 318 may be a second charging information message. The second message 318 may comprise the header from the received message 306. Thus, if the header in the received message 306 is a PANI header, the MMTel AS 212 extracts the PANI header and inserts it into a second message 318. Alternatively, the MMTel AS 212 may extract relevant charging and/or location information from the header in the received message 306, and may generate the second charging information message 318 based on the extracted information.

In particular examples, the MMTel AS 212 may further determine a handover time at which handover from the first radio access network to the second radio access network occurred. The second message 318 may then further comprise an indication of the handover time. For example, the first message may further comprise a handover time and the MMTel AS 212 may read the handover time from the first message. In an alternative example, the MMTel AS 212 may determine the handover time to be the time that the first message 306 is received at the MMTel AS 212.

The MMTel AS 212 then transmits the second message 318 to an entity. In the illustrated example, the entity is the charging entity 302. Alternatively, the entity may be another node in the communications network for processing the second message 318. For example, the MMTel AS 212 may transmit the second message 318 to an entity in the communications network for determining one or more performance indicators and/or statistics. The second message 318 may be transmitted over any suitable interface such as, for example, a Diameter interface.

The MMTel AS 212 may further determine performance indicators and/or statistics based on the received message 306. The performance indicators may be, for example, for one or more of: the first radio access network, the second radio access network and the first network node 202. The performance indicators may include one or more key performance indicators (KPIs) indicative of, for example, accessibility, retainability, integrity, availability and/or mobility of a session and/or a network. The performance indicators may be specific to a particular type of radio access network. The performance indicators may be specific to the MMTel AS 212. For example, the performance indicators may include an indicator of the accessibility of the MMTel AS 212.

As noted above in the description accompanying FIG. 2, a fourth dialog 220 is established between the MMTel AS 212 and the remote media network for the second network node. Thus, the MMTel AS 212 is may be a last node (an edge node) in a trust domain defined by the home media network 222. Alternatively, the fourth dialog 220 may be between the MMTel AS 212 and a further node which is a last node (an edge node) in the trust domain defined by the home media network 222. Accordingly, the contents of messages transmitted over the fourth dialog 220 may be restricted to prevent sensitive information from leaving the home media network 222. In this context, sensitive information may include, for example, location information for the first network node 202. Accordingly, the MMTel AS 212 may consume the received message 306 to prevent the message contents from leaving the trust domain. In other words, the MMTel AS 212 may be configured to not forward the received message to any node not within the trust domain. This consuming of the received message 306 at the last node in the trust domain defined by the home media network 222 may therefore ensure that any sensitive information contained in the received message 306 is not transmitted outside of the trust domain.

In the foregoing description, those skilled in the art will appreciate that the messages may be any suitable message. In particular embodiments, the messages may SIP messages. The messages may be any suitable SIP messages (or any combination of SIP messages), such as, for example, a SIP INFO message, a SIP MESSAGE, a SIP NOTIFY message, a SIP OPTIONS message, a SIP PUBLISH message or a SIP UPDATE message. Preferably, one or more of the messages described above comprises a SIP INFO message and/or a SIP MESSAGE.

Although the disclosures described in relation to FIGS. 2 and 3 are described in the context of a voice call, those skilled in the art will appreciate that the disclosures may similarly be applied to other communication sessions, such as, for example, video sessions, messaging sessions or multimedia sessions comprising a combination of voice, video and messaging.

Similarly, although the foregoing embodiments are described in the context of IMS networks and SIP, those skilled in the art will appreciate that the disclosures may be applied to other types of media networks and/or protocols, and are therefore not limited as such.

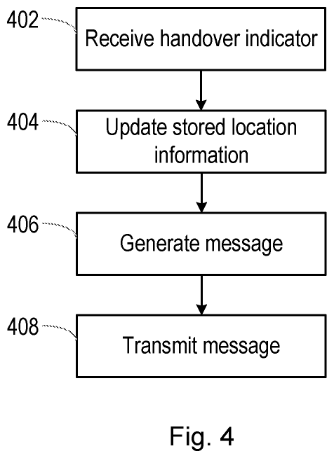

FIG. 4 is a flowchart of a method performed by a first intermediate node in an ongoing communication session between a first network node and a second network node in a communications network according to some embodiments. The first intermediate node may form part of a media network such as, for example, an IMS network. In particular examples, the first intermediate node may be, for example, the P-CSCF 206 illustrated in FIG. 2.

The method begins in step 402 in which the first intermediate node receives an indication that handover of the first network node from a first radio access network to a second radio access network has occurred during the ongoing communication session.

The indication may be received from a second intermediate node in the ongoing communication session. The second intermediate node may be, for example, the PCRF 204 illustrated in FIG. 2.

The first intermediate node may optionally, in step 404, update stored information based on location information received from the second intermediate node. The method then proceeds to step 406.

Alternatively, step 404 may be omitted and the method may proceed directly from step 402 to step 406. In step 406, the first intermediate node generates a message comprising a header, wherein the header identifies the second radio access network.

In step 408, the first intermediate node transmits the message to a third intermediate node in the ongoing communication session.

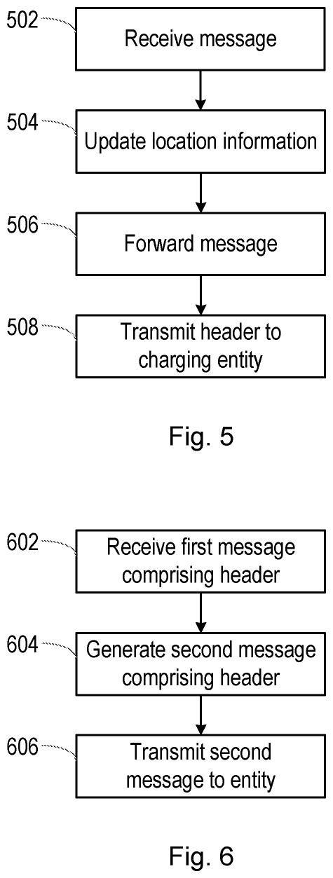

FIG. 5 is a flowchart of a method performed by a first intermediate node in an ongoing communication session between a first network node and a second network node in a communications network according to some embodiments. The ongoing communication session may be, for example, an SIP session. The first intermediate node may form part of a media network such as, for example, an IMS network. In particular embodiments, the first intermediate node may be, for example, the S-CSCF 208 or the SCC AS 210 illustrated in FIG. 2.

In step 502, the method comprises receiving a message indicating that handover of the first network node from a first radio access network to a second radio access network has occurred during the ongoing communication session. The message comprises a header, and the header identifies the second radio access network. The message may be, for example, a PANI header.

The method may then proceed to step 504, which comprises updating stored location information based on location information comprised in the received message. The method then proceeds to step 506. The location information may, for example, identify a cell serving the first network node.

Alternatively, step 504 is omitted, and the method proceeds directly from step 502 to step 506. In step 506, the method comprises forwarding the message to a second intermediate network node in the ongoing communication session.

The method may then optionally proceed to step 508 in which the first intermediate node transmits the header to a charging entity.

FIG. 6 is a flowchart of a method performed by a first intermediate node in an ongoing communication session between a first network node and a second network node in a communications network according to some embodiments. The ongoing communication session may be, for example, an SIP session. The first intermediate node may form part of a media network such as, for example, an IMS network. In particular examples, the first intermediate node may be, for example, the MMTel AS 212 described above in respect of FIG. 2.

In step 602, the method comprises receiving a first message indicating that handover of the first network node from a first radio access network to a second radio access network has occurred during the ongoing communication session. The first message comprises a header, and the header identifies the second radio access network. The header may be, for example, a PANI header.

In step 604, the method comprises generating a second message comprising the header.

In step 606, the method comprises transmitting the second message to an entity in the communication network. The entity may be a charging entity. The second message may be transmitted over an Ro or an Rf interface, for example.

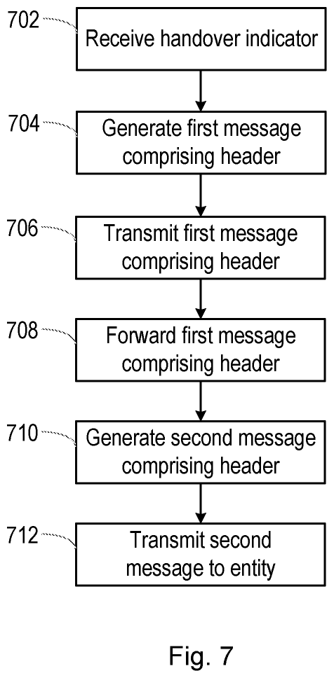

FIG. 7 is a flowchart of a method performed by a system in an ongoing communication session between a first network node and a second network node in a communications network according to some embodiments. The system comprises a first, second and third intermediate node. The first intermediate node may be, for example, the P-CSCF 206 described above in relation to FIG. 3. The second intermediate node may be, for example, the S-CSCF 208 or the SCC AS 210 described above in relation to FIG. 3. The third intermediate node may be, for example, the MMTel AS 212 described above in respect of FIG. 2

The method begins in step 702 in which the first intermediate node receives an indication that handover of the first network node from a first radio access network to a second radio access network has occurred during the ongoing communication session.

In step 704, the first intermediate node generates a first message comprising a header, wherein the header identifies the second radio access network.

In step 706, the first intermediate node transmits the first message. The first message may be optionally transmitted to a second intermediate node in the ongoing communication session. Thus, the second intermediate node receives the first message and, in step 708, forwards the first message to a third intermediate node in the ongoing communication session.

Alternatively, the first message may be transmitted directly from the first intermediate node to the third intermediate node.

The third intermediate node receives the first message and, in step 710, generates a second message comprising the header from the first message.

In step 712, the third intermediate node transmits the second message to an entity in the communications network. The entity may be a charging entity.

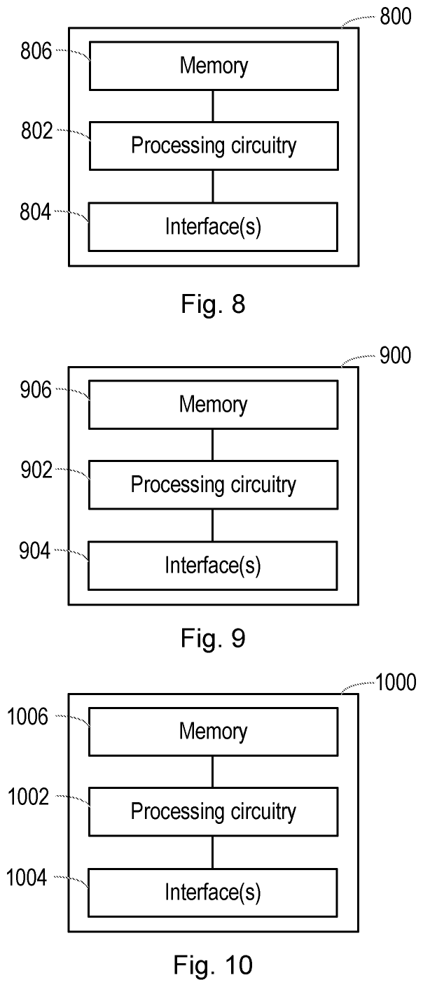

FIG. 8 is a schematic diagram of a first intermediate node 900 in an ongoing communication session between a first network node and a second network node in a communication network according to embodiments of the disclosure.

The first intermediate node 800 comprises processing circuitry (or logic) 802. The processing circuitry 802 controls the operation of the first intermediate node 800 and can implement the method described above with respect to FIG. 4 or the P-CSCF 206 in FIG. 3, for example. The processing circuitry 802 can comprise one or more processors, processing units, multi-core processors or modules that are configured or programmed to control the first intermediate node 800 in the manner described herein.

In particular implementations, the processing circuitry 802 can comprise a plurality of software and/or hardware modules that are each configured to perform, or are for performing, individual or multiple steps of the method described herein in relation to the first intermediate node 800.

Briefly, the processing circuitry 802 of the first intermediate node 800 is configured to: receive an indication that handover of a first network node from a first radio access network to a second radio access network has occurred during the ongoing communication session; generate a message comprising a header, wherein the header identifies the second radio access network; and transmit the message to a second intermediate node in the ongoing communication session.

In some embodiments, the first intermediate node 800 may optionally comprise a communications interface 804. The communications interface 804 of the first intermediate node 800 can be for use in communicating with other nodes, such as other virtual nodes. For example, the communications interface 804 of the first intermediate node 800 can be configured to transmit to and/or receive from other nodes requests, resources, information, data, signals, or similar. The processing circuitry 802 of the first intermediate node 800 may be configured to control the communications interface 804 of the first intermediate node 800 to transmit to and/or receive from other nodes requests, resources, information, data, signals, or similar.

Optionally, the first intermediate node 800 may comprise a memory 806. In some embodiments, the memory 806 of the first intermediate node 800 can be configured to store program code that can be executed by the processing circuitry 802 of the first intermediate node 800 to perform the method described herein in relation to the first intermediate node 800. Alternatively or in addition, the memory 803 of the first intermediate node 800, can be configured to store any requests, resources, information, data, signals, or similar that are described herein. The processing circuitry 802 of the first intermediate node 800 may be configured to control the memory 806 of the first intermediate node 800 to store any requests, resources, information, data, signals, or similar that are described herein.

FIG. 9 is a schematic diagram of a first intermediate node 900 in an ongoing communication session between a first network node and a second network node in a communication network according to embodiments of the disclosure.

The first intermediate node 900 comprising processing circuitry (or logic) 902. The processing circuitry 902 controls the operation of the first intermediate node 900 and can implement the method described above with respect to FIG. 5 or the SCC AS 210 in FIG. 3, for example. The processing circuitry 902 can comprise one or more processors, processing units, multi-core processors or modules that are configured or programmed to control the first intermediate node 900 in the manner described herein. In particular implementations, the processing circuitry 902 can comprise a plurality of software and/or hardware modules that are each configured to perform, or are for performing, individual or multiple steps of the method described herein in relation to the first intermediate node 900.

Briefly, the processing circuitry 902 of the first intermediate node 900 is configured to: receive a message indicating that handover of the first network node from a first radio access network to a second radio access network has occurred during the ongoing communication session, the message comprising a header, wherein the header identifies the second radio access network; and forward the message to a second intermediate network node in the ongoing communication session.

In some embodiments, the first intermediate node 900 may optionally comprise a communications interface 904. The communications interface 904 of the first intermediate node 900 can be for use in communicating with other nodes, such as other virtual nodes. For example, the communications interface 904 of the first intermediate node 900 can be configured to transmit to and/or receive from other nodes requests, resources, information, data, signals, or similar. The processing circuitry 902 of the first intermediate node 900 may be configured to control the communications interface 904 of the first intermediate node 900 to transmit to and/or receive from other nodes requests, resources, information, data, signals, or similar.

Optionally, the first intermediate node 900 may comprise a memory 906. In some embodiments, the memory 906 of the first intermediate node 900 can be configured to store program code that can be executed by the processing circuitry 902 of the first intermediate node 900 to perform the method described herein in relation to the first intermediate node 900. Alternatively or in addition, the memory 903 of the first intermediate node 900, can be configured to store any requests, resources, information, data, signals, or similar that are described herein. The processing circuitry 902 of the first intermediate node 900 may be configured to control the memory 906 of the first intermediate node 900 to store any requests, resources, information, data, signals, or similar that are described herein.

FIG. 10 is a schematic diagram of a first intermediate node 1000 in an ongoing communication session between a first network node and a second network node in a communication network according to embodiments of the disclosure.

The first intermediate node 1000 comprising processing circuitry (or logic) 1002. The processing circuitry 1002 controls the operation of the first intermediate node 1000 and can implement the method described above with respect to FIG. 6 or the MMTel AS 212 in FIG. 3, for example. The processing circuitry 1002 can comprise one or more processors, processing units, multi-core processors or modules that are configured or programmed to control the first intermediate node 1000 in the manner described herein. In particular implementations, the processing circuitry 1002 can comprise a plurality of software and/or hardware modules that are each configured to perform, or are for performing, individual or multiple steps of the method described herein in relation to the first intermediate node 1000.

Briefly, the processing circuitry 1002 of the first intermediate node 1000 is configured to: receive a first message indicating that handover of the first network node from a first radio access network to a second radio access network has occurred during the ongoing communication session, the first message comprising a header, wherein the header identifies the second radio access network; generate a second message comprising the header; and transmit the second message to a charging entity in the communication network

In some embodiments, the first intermediate node 1000 may optionally comprise a communications interface 1004. The communications interface 1004 of the first intermediate node 1000 can be for use in communicating with other nodes, such as other virtual nodes. For example, the communications interface 1004 of the first intermediate node 1000 can be configured to transmit to and/or receive from other nodes requests, resources, information, data, signals, or similar. The processing circuitry 1002 of the first intermediate node 1000 may be configured to control the communications interface 1004 of the first intermediate node 1000 to transmit to and/or receive from other nodes requests, resources, information, data, signals, or similar.

Optionally, the first intermediate node 1000 may comprise a memory 1006. In some embodiments, the memory 1006 of the first intermediate node 1000 can be configured to store program code that can be executed by the processing circuitry 1002 of the first intermediate node 1000 to perform the method described herein in relation to the first intermediate node 1000. Alternatively or in addition, the memory 1003 of the first intermediate node 1000, can be configured to store any requests, resources, information, data, signals, or similar that are described herein. The processing circuitry 1002 of the first intermediate node 1000 may be configured to control the memory 1006 of the first intermediate node 1000 to store any requests, resources, information, data, signals, or similar that are described herein.

The embodiments described herein therefore allow for more accurately monitoring and charging communication sessions in communication networks. In particular, the embodiments described herein enable more accurately monitoring and charging ongoing communication sessions between a first network node and a second network node without requiring any modification of or intervention by the first network node.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

1. A method performed by a first intermediate node in an ongoing communication session between a first network node and a second network node in a communication network, the method comprising:
receiving an indication that handover of a first network node from a first radio access network to a second radio access network has occurred during the ongoing communication session;
generating a message comprising a header, wherein the header identifies the second radio access network; and
transmitting the message to a second intermediate node in the ongoing communication session.

2. The method according to claim 1, wherein the header further identifies a cell serving the first network node.

3. The method according to claim 1, wherein the header is a private access network information (PANI) header.

4. The method according to claim 1, wherein one or more of the following applies:
the ongoing communication session is a session initiation protocol (SIP) session;
the first intermediate node is an SIP proxy; and
the second intermediate node is an SIP proxy server or an SIP application server.

5. The method according to claim 1, wherein one or more of the following applies:
the first intermediate node is a Proxy Call Session Control Function (P-CSCF) node; and
the second intermediate node is a Serving Call Session Control Function (S-CSCF).

6. The method according to claim 1, wherein the ongoing communication session comprises one or more of the following:
a voice call;
a video call; and
a messaging session.

7. The method according to claim 1, wherein the first network node, the second network node, or both the first network node and the second network node comprise:
a wireless device or a server.

8. The method according to claim 1, wherein the first radio access network and the second radio access network are of different radio access technologies.

9-18. (canceled)

19. A first intermediate node in an ongoing communication session between a first network node and a second network node in a communication network, the first intermediate node comprising:
processing circuitry; and
a memory containing program code which, when executed by the processing circuitry, causes the first intermediate node to:
receive an indication that handover of a first network node from a first radio access network to a second radio access network has occurred during the ongoing communication session;
generate a message comprising a header, wherein the header identifies the second radio access network; and
transmit the message to a second intermediate node in the ongoing communication session.

20. The first intermediate node according to claim 19, wherein the header further identifies a cell serving the first network node.

21. The first intermediate node according to claim 19, wherein the header is a private access network information (PANI) header.

22. The first intermediate node according to claim 19, wherein one or more of the following applies:
the ongoing communication session is a session initiation protocol (SIP) session.
the first intermediate node is an SIP proxy; and
the second intermediate node is an SIP proxy server or an SIP application server.

23. The first intermediate node according to claim 19, wherein one or more of the following applies:
the first intermediate node is a Proxy Call Session Control Function (P-CSCF) node; and
the second intermediate node is a Serving Call Session Control Function (S-CSCF).

24. The first intermediate node according to claim 19, wherein the ongoing communication session comprises one or more of the following:
a voice call;
a video call; and
a messaging session.

25. The first intermediate node according to claim 19, wherein the first network node, the second network node, or both the first network node and the second network node comprise:
a wireless device or a server.

26. The first intermediate node according to claim 19, wherein the first radio access network and the second radio access network are of different radio access technologies.

27-36. (canceled)
